(19) United States
(12) Patent Application Publication
(10) Pub. No.: US 2008/0095959 A1
(43) Pub. Date: Apr. 24, 2008

(54) Infusion package

(75) Inventors: Jim F. Warner, Westfield, NJ (US); Emily Moyer, Brooklyn, NY (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: The Republic Of Tea, Nashville, IL (US)

(21) Appl. No.: 11/584,211

(22) Filed: Oct. 20, 2006

(51) Int. Cl. B32B 3/02; B32B 27/10; B32B 5/26

(52) U.S. Cl. 428/34.3; 428/68; 428/36.1; 442/239; 442/301

(57) ABSTRACT

The present invention is directed to a material for use in making beverage infusion packages including a plurality of fibers woven with at least one heat-bondable synthetic fiber. Preferably, the fibers are cellulosic fibers such as bamboo and the heat-bondable synthetic fibers are biodegradable fibers, such as polylactides or polylactic acid. The present invention is also directed to beverage infusion packages made from the material and methods of making the infusion package.

### BACKGROUND OF THE INVENTION

The present invention is related to materials for use in making infusion packages and infusion packages made therefrom.

Known substances for infusion include tea leaves, coffee grounds, medicinal herbs and drinking powders (e.g., cocoa powder). When immersed in a liquid, infusion packages are designed to be porous so as to allow substances contained in the package to infuse the liquid and yet, prevent the substance from leaving the package.

Such packages are known to be made from paper products through traditional paper-making processes such as wet laying or bonding. However, such processes typically result in uneven porosity. Infusion packages are also known to be made from woven cellulosic fibers, such as cotton. Additionally, thermoplastic materials in various forms, such as strings, have been used as adhesives between layers of the infusion packages. However, all of these production and sealing processes require additional manufacturing steps, glues, adhesives or chemicals. Additionally, there has been widespread environmental concern over the increased waste resulting from the disposal of these infusion packages.

### SUMMARY OF THE INVENTION

The present invention is directed to a material for use in making beverage infusion packages including a plurality of fibers woven with at least one heat-bondable synthetic fiber. Preferably, the fibers are cellulosic fibers such as bamboo and the heat-bondable synthetic fibers are biodegradable fibers, such as polylactides or polylactic acid. The present invention is also directed to beverage infusion packages made from the material and methods of making the infusion package.

In accordance with one aspect of the present invention, there is provided a material for use in infusion packages most commonly for beverages. The material includes a plurality of cellulosic fibers woven with at least one heat-bondable synthetic fiber. In one embodiment, the cellulosic fiber is a bamboo fiber and the heat-bondable synthetic fiber is a biodegradable material.

In accordance with another aspect of the present invention, there is provided an infusion package comprised of at least two overlying layers sealed together to form at least one compartment therebetween, wherein at least one of the overlying layers includes a plurality of cellulosic fibers woven with at least one heat-bondable synthetic fiber. The heat bondable material is provided at least within a region of the package where the layers are to be joined.

In another embodiment, the infusion package further includes a tag or tab and a string. The tag or tab and string may be formed as cut-outs from the combined portions of the infusion package. Alternatively, the tag or tab may be formed separately and attached to the infusion package with a string.

In another aspect, there is provided a method for producing an infusion package. In the method, at least two layers are provided overlying one another, wherein at least one of the layers includes a plurality of cellulosic fibers woven with at least one heat-bondable synthetic fiber. At least one infusion substance is proved. The at least two layers are joined together to form at least one compartment there between containing the at least one infusion substance. The joining step may be performed by heat-sealing or other joining techniques.

In another embodiment, the method further comprises the step of forming a tag or a tab and a string connected to at least one of the layers, in which the tag or tab and string are formed from the joined portions of the layers. In the alternative, the tag or a tab may be made separately and attached to one or more layers by a string.

### BRIEF DESCRIPTION OF THE DRAWINGS

FIG. 1 is an enlarged front elevational view of a layer of a material in accordance with the present invention.

FIG. 2 is a fragmentary perspective view of an infusion package in accordance with an embodiment of the present invention with one compartment.

FIG. 3 is a fragmentary perspective view of an infusion package in accordance with an embodiment of the present invention with multiple compartments.

### DETAILED DESCRIPTION

In describing the preferred embodiments of the present invention, specific terminology will be resorted to for the sake of clarity. However, the invention is not intended to be limited to the specific terms so selected, and is to be understood that each specific term includes all technical equivalence which operate in a similar manner to accomplish a similar purpose.

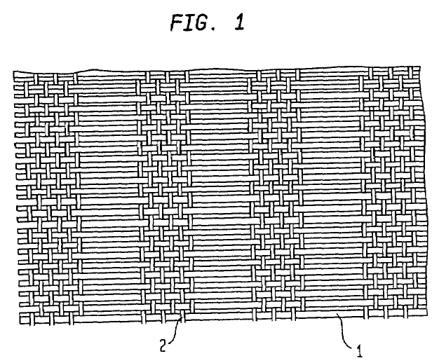

According to one aspect, the present invention is directed to a material for use in beverage infusion packages. The material in accordance with one embodiment includes at least one cellulosic fiber woven together with at least one heat-bondable synthetic fiber. In the material, preferably, a plurality of cellulosic fibers are woven together with at least one heat-bondable synthetic fiber. The fibers are typically elongated and may be arranged in the woven portion as either weft or warp fibers, or both. In the particular embodiment shown in FIG. 1, the weft fibers 1 run horizontal and intersect the weft fibers 2 that run lengthwise. The weft fibers 1 and the warp fibers 2 may include cellulosic fibers only, polymer fibers only, heat-bondable synthetic fibers only or both cellulosic fibers and/or polymer fibers and heat-bondable fibers. The only requirement is that at least one heat-bondable synthetic fiber is present as the weft and/or warp fibers for heat sealing of the infusion package. In the preferred embodiment, at least some of the fibers in the material will be cellulosic fibers.

In general, the fibers for use in the present invention may be any thickness so long as they are weavable and strong enough to withstand the infusion process (e.g., being immersed in a heated liquid for at least the requisite amount of time for infusing the liquid with the infusion substance without disintegrating). A suitable cellulosic fiber is about 32 denier. A suitable heat-bondable synthetic fiber is about 26 denier. The cellulosic fibers may be any fiber made from any plant, cellulose or derivative of cellulose. A preferred cellulosic fiber is bamboo. Bamboo transfers moisture well and has been found to suitable for use with biodegradable synthetic fibers, such as polylactic acid. Other suitable fibers include but are not limited to cotton, linen, flax, ramie, silk, abaca and viscose.

The heat-bondable synthetic fibers may be any synthetic fiber capable of being bonded to another heat-bondable synthetic fiber and/or the cellulosic fibers through application of heat, such as through heat-pressing. Without limitation, suitable heat-bondable synthetic fibers include heat-bondable polymers, thermoplastics and resins, such as heat-bondable polyolefins, polyesters, polyamides, polyhydroxyalkanoates and polysaccharides. Some specific heat-bondable synthetic fibers include: polypropylene, polyethylene, ethylene acrylic acid and ethylene vinyl acetate. Preferably heat-bondable synthetic fibers having a bonding temperature above one hundred degrees Centigrade is desirable.

Preferably, the heat-bondable synthetic fibers are biodegradable, but not required. Such fibers are those fibers that are heat-bondable, but are capable of being broken down by living things (especially, microorganisms), such as bacteria and fungi, under natural conditions. Suitable heat-bondable biodegradable synthetic fibers for use in the infusion package of the present invention include fibers made from biodegradable thermoplastics or thermopolymers, such as biodegradable aliphatic polyester polymers. Such biodegradable aliphatic polyester polymers include: polyhydroxy butyrate (PHP), polyhydroxy butyrate-co-valerate (PHBV), polycaprolactane, polybutylene succinate, polybutylene succinate-co-adipate, polyglycolic acid (PGA), polylactide or polylactic acid, polybutylene oxalate, polyethylene adipate, polyparadioxanone, polymorpholineviones, and polydioxipane-2-one.

A particularly preferred heat-bondable biodegradable synthetic fiber is polylactic acid or polylactide. Polylactic acid and polylactides are commonly referred to as PLAs. PLAs are commercially available from Yamanaka Industry Co. Ltd. under several trade names including Tearoad Soilon®. PLAs are also described in U.S. Pat. No. 5,338,822 (Gruber et al.); U.S. Pat. No. 6,111,060 (Gruber et al.); U.S. Pat. No. 5,556,895 to (Lipinsky et al.); U.S. Pat. No. 5,801,223 (Lipinsky et al.); U.S. Pat. No. 6,353,086 (Kolstad et al.); and U.S. Pat. No. 6,506,873 (Ryan et al.), each of which hereby incorporated by reference in its entirety.

Any known process for weaving fibers may be employed in the process for producing layers of the material. For example, as shown in FIG. 1, a first plurality of fibers in a warp direction, or warp fibers 2, may be woven with a second plurality of fibers in a substantially perpendicular weft direction, or weft fibers 1. Different weave patterns may be achieved by varying the density and using different combinations of fibers in both the weft and warp directions. In this manner, the porosity can be tailored to be more uniform or less uniform. In addition, the porosity can be tailored for different areas of the material if desired. By way of example, a layer may be comprised of cellulosic fibers woven with heat-bondable biodegradable synthetic fibers, or alternating cellulosic and heat-bondable biodegradable synthetic fibers woven with alternating cellulosic and heat-bondable biodegradable synthetic fibers, as well as combinations thereof.

The weave pattern may be tailored to produce a specified porosity, from a tightly woven layer (with decreased porosity) to a loosely woven layer (with increased porosity). However, the weave pattern must not be so solid as to prevent the infusion of an infusion substance held in an infusion package comprising the layer and not so loose as to release more than a minor amount of the infusion substance out of the infusion package.

The weave pattern may also be tailored and/or specific fibers (i.e., colorless or near-colorless fibers) may be chosen so that the layer is transparent, in that the woven fibers allow light to pass through them so that the infusion substance may be partially or fully visible through the woven fibers.

The fibers may also be treated (e.g., color-treated) and woven together in a selected weave pattern so that the woven layer demonstrates a visible and/or textured effect, such as an emblem, letter(s), word(s), logo, symbol or design.

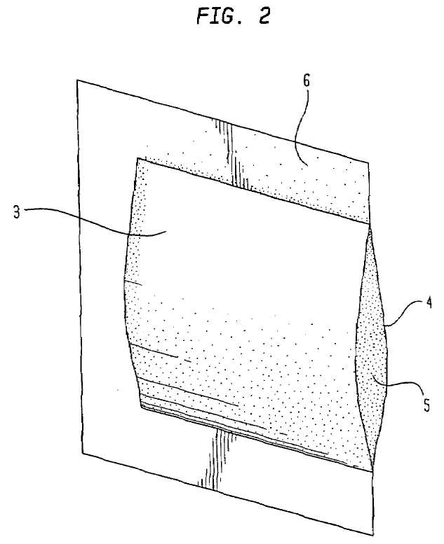

According to another aspect, the present invention is also directed to an infusion package comprised of the material of the present invention. As shown in FIG. 2, an infusion package of the present invention includes at least a first layer 3, and optionally a second layer 4. The first and second layers 3,4 are made from various combinations of cellulosic fibers woven with heat-bondable synthetic fibers. As shown in FIG. 2, the infusion package typically includes the second layer 4, although the infusion package is not limited to only two layers. As discussed later, more layers may be added for design and functional purposes (e.g., to add more compartments). The first and second layers 3,4 are sealed together by the heat-bondable synthetic fiber in such a manner as to form a sealed compartment 5 between the layers 3,4 for holding substances for infusion, such as tea leaves or coffee grounds. Thus, only one heat-bondable synthetic fiber need be woven into one of the two layers only in the area to be sealed.

Although the infusion package has been described as constituting generally two or more separate layers of material, it is contemplated that the two layers can be formed from a single layer. In this regard, a single layer can be folded over itself and heat sealed as thus far described to form the resulting two layers of the infusion package to define the compartment. In this regard, the layer of material will include cellulosic fibers woven together in any combination with at least one heat-bondable synthetic fiber arranged in the bond area of the infusion package. The sealed compartment 5 is defined by the sealed portion 6 of the infusion package. Although shown as substantially square in FIG. 2, the layers 3,4 and sealed compartment 5 may be any desired shape. For example, the layers 3,4 and sealed compartment 5 may be substantially rectangular, oblong or circular in shape. Additionally, although only one compartment 5 is shown in FIG. 2, the layers 3,4 may be sealed together in such a manner as to form multiple compartments with the same volume or different volumes.

As thus far described, the layers 3,4 may be made by weaving various combinations of cellulosic fibers together in any combination with at least one heat-bondable synthetic fiber in the area to be bonded. For example, both layers may be combinations of cellulosic and one or more heat-bondable fibers. Further, one layer may be the combination of cellulosic and at least one heat-bondable fiber, and the other layer either cellulosic fibers or heat-bondable fibers. Accordingly, only one layer is required to contain a heat-bondable fiber in the bond region. In the embodiment as shown in FIG. 2, the first layer 3 and second layer 4 may be heat-sealed in any region where the heat-bondable fiber or fibers are present in the opposing layers. It is also contemplated that cellulosic fibers and heat-bondable fibers of different material compositions made be included in each of the layers.

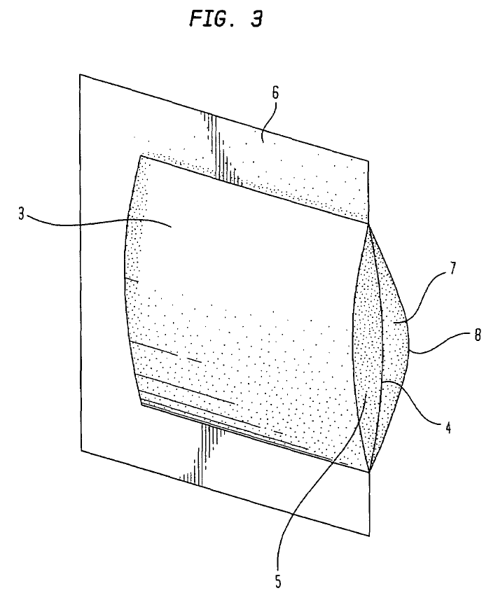

Although FIG. 2 shows an infusion package with two layers, the infusion package of the present invention may include more than two layers. In an infusion package with more than two layers, the additional layer or layers allow for more design choices for the infusion package, including multiple compartments for the infusion substances. For instance, in the embodiment shown in FIG. 3, for an infusion package having three layers, one compartment 5 may be formed between the first and second layers 3,4, and a second compartment 7 may be formed between the second and third layers 4,8. The different compartments could hold the same substance or different substances for infusion in the same amount or different amounts. Thus, the compartments may be of different size, shape and position in the infusion package. By varying the weave pattern and composition for the different layers, thereby controlling porosity, the rate of infusion for the substances in the different compartments may be separately controlled. These three layers may be heat bonded together using the heat-bondable fibers woven into one or more of the layers as thus far described.

The infusion package of the present invention may also include a device for facilitating placement and/or removal of the infusion package into a container with the liquid to be infused. One known such device is a tag or tab connected to a string, in which the string is attached to the infusion package. The string may be attached to the infusion package by being stitched into one or more layers of the infusion package. If the string is made of a material capable of being heat-bonded to the layers, it also may be attached to the infusion package by heat-bonding or fusing it to one or more layers of the infusion package. Alternatively, the string may be made from the sealed layers themselves, from the heat-pressed portions of the infusion package. In this form, the string is cut out of the heat-sealed portions, such that the string is connected to the infusion package, but contains a free end. Then, a tag or tab is attached to the free end of the cut out-string. In another form, both the string and tag are cut out of the heat-sealed portions. The cut-out strings and tags for use in the infusion package may be in any form so long as the layers remain sealed such that any compartments remain intact.

The infusion substances for use with the present invention may be any known substance for infusion. Typically, such infusion substances are for infusing liquids, such as water, to impart flavors or chemical substances, such as medicinal compounds, into the liquid. Suitable infusion substances for use with the infusion package of the present invention, include tea leaves, coffee grounds, medicinal herbs and drinking powders (e.g., cocoa powder).

In accordance with another aspect, the present invention is also directed to a method of producing an infusion package.

In the method, at least one layer including the material of the present invention is provided, along with at least one infusion substance. Then, the layer or layers of cellulosic fiber woven with at least one heat-bondable synthetic fiber may be combined with each other or with one or more additional layers to form the least one compartment of the infusion package. The one or more compartments are defined by one or more combined portions of the combined layers, and contain the one or more infusion substances.

In a preferred embodiment, the sealing of the layers is performed through heat-sealing. The heat-sealing of the layers together may be through any method of applying heat sufficient to bond the layers together so that they will not come apart during the infusion process (e.g., when immersed in heated water for the requisite time for infusing the water with the infusion substance). Sealing methods may include pressing, ultrasonic welding, and radio frequency welding. One particularly preferable heat-sealing method is heat-pressing.

The layers, separately or together, may be pre-cut into desired shapes for the infusion package prior to the sealing step. Alternatively, the sealed layers may be cut into the desired shape after the layers are sealed together.

Additionally, concurrently with or after the sealing step, the present method may include the step of attaching a string with a tab or tag to the infusion package. The attachment may be through stitching the string into one or more layers of the infusion package, or if the string is capable of being heat-bonded to any layer of the infusion package, the attachment may be through heat-bonding the string to the one or more layers of the infusion package.

Alternatively, after the layers are sealed, a string with or without a tab or tag may be cut out of the combined portions in a manner that leaves the string or string with tab or tag connected to the infusion package. If the cut-out string does not include a tag or tab, a tag or tab may be attached to the free end of the string after cutting out the string.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A material for use in an infusion package comprising a plurality of cellulosic fibers woven with at least one heat-bondable synthetic fiber.

2. The material of claim 1, wherein at least a portion of said cellulosic fibers is bamboo.

3. The material of claim 1, wherein said heat-bondable synthetic fiber is selected from the group consisting of polypropylene, polyethylene, ethylene acrylic acid and ethylene vinyl acetate.

4. The material of claim 1, wherein said heat-bondable synthetic fiber is a biodegradable fiber.

5. The material of claim 4, wherein said biodegradable fiber is selected from the group consisting of polyhydroxy butyrate (PHP), polyhydroxy butyrate-co-valerate (PHBV), polycaprolactane, polybutylene succinate, polybutylene succinate-co-adipate, polyglycolic acid (PGA), polylactide acid (PLA), polylactic acid (PLA), polybutylene oxalate, polyethylene adipate, polyparadioxanone, polymorpholineviones and polydioxipane-2-one.

6. The material of claim 5, wherein said biodegradable fiber is polylactide or polylactic acid.

7. The material of claim 1, wherein a portion of said material defines a heat sealable area containing said heat-bondable synthetic fiber.

8. An infusion package comprising at least two overlying layers sealed together to form at least one compartment therebetween, wherein at least one of said overlying layers includes a plurality of cellulosic fibers woven with at least one heat-bondable synthetic fiber.

9. The infusion package of claim 8, wherein at least another one of said overlying layers includes a plurality of cellulosic fibers.

10. The infusion package of claim 8, wherein a portion of said overlying layers defines a heat sealable area containing said heat-bondable synthetic fiber.

11. The infusion package of claim 10, wherein said heat-bondable synthetic fiber is selected from the group consisting of: polypropylene, polyethylene, ethylene acrylic acid and ethylene vinyl acetate.

12. The infusion package of claim 8, wherein said heat-bondable synthetic fiber is biodegradable material selected from the group consisting of: [polyhydroxy butyrate (PHP), polyhydroxy butyrate-co-valerate (PHBV), polycaprolactane, polybutylene succinate, polybutylene succinate-co-adipate, polyglycolic acid (PGA), polylactide acid, polylactic acid, polybutylene oxalate, polyethylene adipate, polyparadioxanone, polymorpholineviones, and polydioxipane-2-one.

13. The infusion package of claim 8, wherein said at least two overlying layers are formed from a single unitary layer folded over itself.

14. The infusion package of claim 8, further including a third layer disposed between said two overlying layers, said third layer forming said one compartment on one side of said third layer and another compartment on the other side of said third layer.

15. The infusion package of claim 8, wherein said cellulosic fibers are bamboo fibers.

16. An infusion package comprising at least two overlying layers sealed together about a portion of their periphery within a bond region to form at least one compartment therebetween, wherein at least one of said layers includes a plurality of fibers woven together, at least one of said fibers comprising a heat-bondable synthetic fiber present in at least said bond region, said heat-bondable synthetic fiber bondable to the other of said layers.

17. The infusion package of claim 16, wherein said heat-bondable synthetic fiber is selected from the group consisting of: polypropylene, polyethylene, ethylene acrylic acid and ethylene vinyl acetate.

18. The infusion package of claim 16, wherein said heat-bondable synthetic fiber is biodegradable material selected from the group consisting of: [polyhydroxy butyrate (PHP), polyhydroxy butyrate-co-valerate (PHBV), polycaprolactane, polybutylene succinate, polybutylene succinate-co-adipate, polyglycolic acid (PGA), polylactide acid, polylactic acid, polybutylene oxalate, polyethylene adipate, polyparadioxanone, polymorpholineviones, and polydioxipane-2-one

19. The infusion package of claim 16, wherein said at least two overlying layers are formed from a single unitary layer folded over itself.

20. The infusion package of claim 16, wherein said plurality of fibers are bamboo fibers.

21. A method for producing an infusion package comprising:
providing at least two layers overlying one another, wherein at least one of said layers includes a plurality of cellulosic fibers woven with at least one heat-bondable synthetic fiber,
providing at least one infusion substance,
joining said at least two layers together to form at least one compartment there between containing said at least one infusion substance.

22. The method of claim 21, wherein said joint comprises heat sealing said layers about a peripheral portion thereof.

23. The method of claim 21, further comprising a step of cutting said layers into a desired shape prior to joining said layers.

24. The method of claim 21, further comprising a step of cutting said layers into a desired shape after joining said layers.
